(19) United States
(12) Patent Application Publication
(10) Pub. No.: US 2009/0317621 A1
(43) Pub. Date: Dec. 24, 2009

(54) Stimuli-Responsive Polymeric Surface Materials

(76) Inventors: Jeffrey P. Youngblood, Crawfordsville, IN (US); John A. Howarter, Arlington, VA (US)

Correspondence Address: BRINKS HOFER GILSON & LIONE, P.O. BOX 10395, CHICAGO, IL, 60610, US

(21) Appl. No.: 12/506,410

(22) Filed: Jul. 21, 2009

Related U.S. Application Data
(63) Continuation-in-part of application No. 11/998,876, filed on Nov. 30, 2007.
(60) Provisional application No. 60/872,332, filed on Nov. 30, 2006.

(51) Int. Cl. B32B 3/26; C08F 16/24; B32B 27/06

(52) U.S. Cl. 428/319.3; 526/247; 428/451

(57) ABSTRACT

A copolymer comprises a first monomer including a hydrophilic group and a hydrophobic group linked to the hydrophilic group, and a second monomer polymerized to the first monomer. The hydrophobic group is oil-repellant. A receding contact angle of a low surface energy fluid on the copolymer is greater than an advancing contact angle of a high surface energy fluid on the copolymer.

The present application is a continuation-in-part application of U.S. patent application Ser. No. 11/998,876, filed Nov. 30, 2007, which claims priority to U.S. Provisional Patent Application Ser. No. 60/872,332, filed Nov. 30, 2006, the entireties of both of which are hereby incorporated by reference.

### FIELD OF THE INVENTION

The present invention relates to stimuli-responsive polymeric surface materials. More particularly, the present invention relates to self-cleaning and anti-fog surfaces, and membrane surfaces coated with the stimuli-responsive polymeric surface materials.

### BACKGROUND OF THE INVENTION

High energy hydrophilic surfaces are prone to fouling from organic contaminates, which can ruin their hydrophilic nature. Oleophobic surfaces that resist fouling can be obtained by modifying materials with a low energy coating, often fluorine-based. However, the modification also renders the surface hydrophobic, which can limit potential applications. Contact lenses and other hydrogel applications are examples of this design dilemma as these materials require hydrophilicity but are preferentially fouled by airborne or solution-based trace organic contaminates. Restoration of hydrophilicity often requires rigorous cleaning procedures that can interfere with device performance. Thus, there is a need to provide hydrophilic surfaces which resist contamination.

Water treatment and fluid filtration is a worldwide industrial, environmental, and health concern, and presents similar challenges in surface engineering. Industrially, offshore oil drilling requires large amounts of filtered seawater for oil recovery. Similarly, water impurities must be removed from fuels to preserve engine lifetimes. A variety of other industries, including aluminum, steel, textile and food processing generates great amounts of contaminated waste water, the most abundant contaminant being oil and grease. The contaminated water must be treated before disposal. Moreover, drinking water standards are continuously increasing, as is the need to purify drinking water in an economically and energy efficient way. The use of membranes alone or in conjunction with flocculants and coagulants is a common solution for water treatment. Thus, for environmental and health concerns in addition to industrial applications, there is a need to separate oil-in-water emulsions. Membrane enhancements that work for the former application will not necessarily be preferred for the latter application although both engineering problems are centered on improving the coalescence of micron-size dispersants.

Surface modification of microfiltration and ultrafiltration membranes for water treatment is often used in the design of membranes for improved fouling resistance, chemical selectivity, or permeability. Membrane performance is greatly compromised due to fouling that can be defined as pore clogging via particulates, preferential adsorption of fluids, or the formation of cake layers, all of which lead to a reduction in fluid flux. Approaches to anti-fouling surfaces often include masking the surface with grafted or adsorbed polymers, which have minimal interaction with foulants. Advanced membranes use a combination of size exclusion and chemical selectivity as mechanisms to separate complex mixtures.

The use of stimuli-responsive materials as surface modifiers has produced membranes which act as chemical gates. By taking advantage of differences in polymer-solute interactions, it is possible to control the selectivity of a membrane. Stimuli-responsive materials have the ability to display large changes in their properties based on an external stimulus. The selectivity and the necessary stimulus required to gamer a response in material properties is a design parameter allowing for “tunable” response characteristics. For example, the transition temperature for thermally sensitive block copolymers can be manipulated by altering the composition of the constituent blocks. In addition to temperature, examples of common stimuli include pH, light, electrical potential, specific ion pairs, and solvent environment. Examples of applications being explored for stimuli-responsive surfaces are diverse, including photolithography, chemical gating, as well as various biomedical applications.

Polymer brushes are macromolecules tethered to a surface either through covalent attachment or physical adsorption and can be used as stimuli-responsive surfaces. Covalent attachment is often preferred due to inherent resistance to degradation by solvents. Polymers can be attached to surfaces using a grafting-from technique or a grafting-to technique. The grafting-from technique requires well controlled polymerization of polymers via surface immobilized initiators. Compositionally controlled, thick brush layers can be created using the grafting-from technique while a high grafting density is maintained. The grafting-to technique employs polymers that are pre-synthesized and attached to the surface by chemical or physical means. Lower brush densities are expected from the grafting-to technique, as the hydrodynamic volume of the individual polymer chains excludes potential grafting sites in the initial stages of attachment. Higher brush density corresponds to better performance due to a more complete defect-free coverage of the surface.

A disadvantage of grafting-from based stimuli-responsive polymer brushes is in the response time necessary to elicit a change in properties, particularly when using solvents as the stimulus. Solvent-sensitive stimuli-responsive brush systems are often composed of either block copolymers or mixed polymer brushes. In either case, two distinct polymer constituents of dramatically different surface energy characteristics are present on the surface so that changes in wettability occur upon switching. By treating the surface with solvents selective to only one of the polymer types, rearrangement occurs revealing either the high or low surface energy constituent. Since solvent-sensitive polymer brushes respond through a change in the conformation of the brush, prolonged pretreatment with solvents is often necessary to induce switched wetting behavior. As the chain length of the brush increases, the response time for the surface change will also increase.

Other previously reported stimuli-responsive surfaces are either superhydrophobic or superhydrophilic with extreme wetting behavior. These surfaces can be coated with a single hydrophobic group, such as polystyrene, or a combination of two hydrophobic groups, with different level of hydrophobicity. Maximum coating density is required for these surfaces to be stimuli-responsive. One disadvantage of these reported stimuli-responsive surfaces is that they focused on altering the entire surface character in order to induce a change in wetting behavior. Such systems manipulate the surface to change the contact angle response toward a common liquid depending on the treatment history. Switching behavior in wettability is not available.

Thus, it is one object of the present invention to provide novel stimuli-responsive polymeric surface materials that elicit a change in wettability upon solvent exposure. For a given surface, wettability is dominated by the surface tension of the fluids. For example, hexadecane has a lower surface energy than water, thus for identical homogeneous substrates hexadecane will have a lower contact angle than water. The novel solvent sensitive stimuli-responsive surfaces provide a means to overcome this limitation of thermodynamic surface behavior. The novel polymeric materials based on fluorinated surfactants showed stimuli-responsive behavior that rendered surfaces oil-repellant and hydrophilic.

The present invention provides surfaces that exhibit simultaneous hydrophilicity and oleophobicity using covalently attached surfactants grafted to silica surfaces. It is thus possible for a thin contamination layer to be macroscopically removed from the surfactant based coating with gently flowing water, obviating the need for additional agitation or chemical treatment to clean the surface. Because the water contact angle on the surfactant modified surfaces is lower than the contact angle of the foulant (for example, hexadecane), it is favorable for water to displace hexadecane on the surface. Such surfaces have also been shown to mitigate fog formation as water droplets condense as a continuous sheet due to the hydrophilic nature of the surface.

### BRIEF SUMMARY OF THE INVENTION

A first monomer including a hydrophilic group and a hydrophobic group linked to the hydrophilic group is polymerized to a second monomer to form a copolymer. The hydrophobic group is oil-repellant. A receding contact angle of a low surface energy fluid on the copolymer is greater than an advancing contact angle of a high surface energy fluid on the copolymer.

A device comprises a surface and at least part of the surface may be coated with a copolymer, which includes a first monomer polymerized to a second monomer. The first monomer comprises a hydrophilic group and a hydrophobic group linked to the hydrophilic group. The hydrophobic group is oil-repellant. The copolymer is presented on the surface in a configuration and the amount of the copolymer coated onto the surface is adjusted in a manner such that a receding contact angle of a low surface energy fluid on the surface is greater than an advancing contact angle of a high surface energy fluid on the surface.

In another example, a device comprises a surface and at least part of the surface is coated with a compound. The compound comprises a hydrophilic group and a hydrophobic group linked to the hydrophilic group. The hydrophobic group is oil-repellant. The compound is presented on the surface in a configuration and the amount of the compound coated onto the surface is adjusted in a manner such that a receding contact angle of a low surface energy fluid on the surface is greater than an advancing contact angle of a high surface energy fluid on the surface.

### BRIEF DESCRIPTION OF THE DRAWINGS

FIG. 1 is an illustration of the characterization of water and hexadecane behavior on f-PEG brushes.

FIG. 2 is an illustration of bulk flow rate of water and hexadecane through unmodified membranes and f-PEG brush modified membranes.

FIG. 3 is an illustrative view of the dynamic wetting response of f-PEG modified D membrane. (A) Hexadecane drop is placed on membrane surface with static contact angle >˜100°, and water droplet is suspended from the syringe tip. (B) Water droplet placed atop hexadecane quickly displaces hexadecane on membrane surface. Hexadecane droplet expands across the water interface as water droplet passes through membrane pores. (C) Once water drop fully passes hexadecane remains stable on membrane surface. Reduced contact angle of hexadecane is result of spreading on surface of water drop seen in (B).

FIG. 4 is an illustrative view of the permeability (L/min/m²/Torr) of water (shaded black bars) and hexadecane (white bars) through unmodified membranes and f-PEG modified membranes.

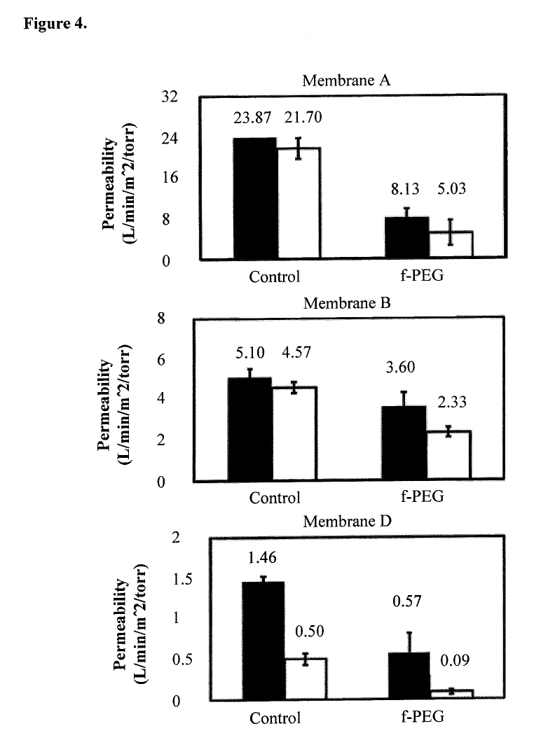

FIG. 5 is an illustrative view of the three step process of (1) capture of dispersed oil droplet at f-PEG modified membrane surface, followed by (2) coalescence of multiple oil droplets and finally (3) rejection of the oil droplet.

FIG. 6 is an illustration of evolution of the carbon signal for about 75° XPS scans of f-PEG brush surfaces.

FIG. 7 is an illustration of XPS analysis of fluorine content in f-PEG brushes.

### DETAILED DESCRIPTION OF THE INVENTION

The present invention relates to stimuli-responsive polymeric surface materials. More particularly, the present invention relates to self-cleaning and anti-fog surfaces, and membrane surfaces coated with the stimuli-responsive polymeric surface materials. The novel stimuli-responsive polymeric surface materials can be used to manufacture devices that are both oil-resistant and self-cleaning, for example, cold windshields, eyeglasses, safety glasses, and ski and SCUBA goggles.

A copolymer comprising a first monomer polymerized to a second monomer is provided. The first monomer comprises a hydrophilic group and a hydrophobic group linked to the hydrophilic group. The hydrophobic group is oil-repellant. A receding contact angle of a low surface energy fluid on the copolymer is greater than an advancing contact angle of a high surface energy fluid on the copolymer.

Preferably, the hydrophilic group is longer than the hydrophobic group. Suitable hydrophilic groups include, but are not limited to, poly(ethylene glycol), poly(vinyl alcohol), poly(acrylic acid), poly(methacrylic acid), poly(vinyl pyrrolidone), or any other hydrophilic backbone groups. In one example, the hydrophilic group is poly(ethylene glycol).

Suitable hydrophobic groups include, but are not limited to, a fluorinated group, hydrophobic siloxane, and an alkyl group. In one example, the hydrophobic group is a fluorinated group. The fluorinated group may be either perfluorinated or partially fluorinated. Suitable fluorinated groups include, but are not limited to, perfluorinated alkyl and partially fluorinated alkyl. Suitable alkyl groups include, but are not limited to, a hydrocarbon group that may be linear, cyclic, or branched or a combination thereof. Examples of alkyl groups include, but are not limited to, methyl, ethyl, n-propyl, isopropyl, n-butyl, t-butyl, isobutyl, sec-butyl, cyclohexyl, cyclopentyl, (cyclohexyl)methyl, cyclopropylmethyl, bicyclo[2.2.1]heptane, bicyclo[2.2.2]octane. Alkyl groups may be substituted or unsubstituted, unless otherwise indicated.

The first monomer further comprises a polymerizable group, through which the first monomer is polymerized to the second monomer. Any suitable polymerizable group may be used. For example, the polymerizable group is a methacrylate group. The first monomer may be poly(ethylene glycol) modified by a fluorinated group and a methacrylate group. In an example, the first monomer is poly(ethylene glycol) with a perfluorinated alkyl head group and a methacrylate tail group.

Any monomer that is polymerizable toward the polymerizable group in the first monomer may be used as a second monomer. Suitable second monomers include, but are not limited to, acrylic acid, methyl methacrylate, 4-vinyl pyridine, and hydroxyethyl methacrylate. In one example, the second monomer is acrylic acid.

The feed ratio of the first monomer and the second monomer for polymerization may be varied to adjust the surface properties of the copolymer. For example, a feed ratio of the first monomer and the second monomer for polymerization may be from about 1:99 mol % to about 50:50 mol %. Further, the feed ratio may be from about 1:99 mol % to about 10:90 mol %.

The copolymer may be a random copolymer. Preferably, the copolymer is substantially not water soluble. The copolymer may be both hydrophilic and oleophobic.

The low surface energy fluid may be an oil. The high surface energy fluid may be water. In one example, the advancing contact angle of the high surface energy fluid is lower than about 40°.

At least part of the surface of a device may be coated with a copolymer described above. The copolymer may include a first monomer polymerized to a second monomer. The first monomer comprises a hydrophilic group and a hydrophobic group linked to the hydrophilic group. The hydrophobic group is oil-repellant. The copolymer is presented on the surface in a configuration and the amount of the copolymer coated onto the surface is adjusted in a manner such that a receding contact angle of a low surface energy fluid on the surface is greater than an advancing contact angle of a high surface energy fluid on the surface.

Preferably, the first monomer is poly(ethylene glycol) modified by a fluorinated group and a methacrylate group. The copolymer may be covalently bonded to a surface using any surface chemistry. Alternatively, the copolymer also may be non-covalently linked to a surface using any available methods. Suitable non-covalent methods include, but are not limited to, spin coating, spraying, dipping coating, spin casting, and antibody-antigen interactions.

In an example, at least some of the part of the copolymer corresponding to the second monomer contacts the surface. The copolymer may have a bulky form. Preferably, the surface is water-wettable. More preferably, water forms a substantially continuous sheet on the surface.

The surface of the device may be a water swellable and porous surface. In one example, the surface is a silica surface. The low surface energy fluid may be an oil, the high surface energy fluid may be water, and the advancing water contact angle may be about 40° lower than receding hexadecane contact angle.

In another example, a device comprises a surface and at least part of the surface is coated with a compound. The compound is also referred to as a polymer brush. The compound comprises a hydrophilic group and a hydrophobic group linked to the hydrophilic group. The hydrophobic group is oil-repellant. The compound is presented on the surface in a configuration and the amount of the compound coated onto the surface is adjusted in a manner such that a receding contact angle of a low surface energy fluid on the surface is greater than an advancing contact angle of a high surface energy fluid on the surface.

Any suitable chemical or physical methods can be used to coat the compound to the surface of the device. For example, the compound can be coated to the surface using standard coupling methods. For example, when the compound has a hydroxyl group, it can be coupled to a silica surface using standard surface modification chemistry. Alternatively, when the compound has a maleimidyl or an alpha-halo-amide group, it can be coupled to a surface that is modified to present a thiol group (such as Cys), forming a thioether linkage. Alternatively, when the compound comprises an antibody, it can be coupled to a surface that is modified to present an antigen. Alternatively, when the compound comprises an antigen, it can be coupled to a surface that is modified to present an antibody. Alternatively, when the compound has an amine group, it can be coupled to a surface that contains a carboxylic acid, forming an amide linkage. Alternatively, when the compound has a thiol group, it can be coupled to a surface that contains a thiol group (such as Cys), forming a disulfide linkage. Alternatively, when the compound has a carboxylic acid, it can be coupled to a surface that contains an amine. Alternatively, when the compound has an aldehyde, it can be coupled to a surface that contains amine via reductive amination. Preferably, the compound is covalently coated to the surface. Other surfaces and coating methods are described in U.S. Patent Application Publication No. 2007-0048249, published Mar. 1, 2007, the entirety of which is incorporated herein by reference.

The surface of the device may be a silica surface. The hydrophilic group may be poly(ethylene glycol) and the hydrophobic group may be a fluorinated group. In one example, the compound has a brush-like form. The low surface energy fluid may be an oil, the high surface energy fluid may be water, and the advancing water contact angle may be about 40° lower than receding hexadecane contact angle.

The surface of the device coated with the copolymer or polymer brush as discussed above shows a receding oil contact angle higher than the advancing water contact angle. This effect leads to self-cleaning by thermodynamic means, not through physical structuring. The fact that oil shows a high contact angle also means that the surface does not foul easily. Moreover, as the surface is water-wettable, it shows anti-fog behavior. But unlike other hydrophilic materials, the surface coated with the novel material as discussed above does not foul with adventitious oil from the air that may ruin the anti-fog capability.

The effect of being self-cleaning occurs when the copolymer or the polymer brush does not dissolve, and thus is not removed, from the surface. After either chemical attachment to the surface or copolymerization into a non-soluble polymer that is coated to the surface, the novel stimuli-responsive material is not dissolvable from the surface. The resultant oleophobic, but hydrophilic, behavior of the surface leads to self-cleaning.

The behavior of the surfaces is coating density-dependant. Non-maximal coating density is preferred. A density higher than the preferred optimum non-maximal density decrease the performance of the surfaces, which is contrary to prior brush systems wherein the coating density is maximized in order to possess self-cleaning or anti-fog properties. The non-maximal coating density of the novel stimuli-responsive material allows some amount of free volume on the surface to show optimum behavior.

The novel stimuli-responsive material has an end-group on the amphiphile presented on the top of the surface. The end-group is both oleophobic and hydrophobic, and insoluble in both oil and water. Preferably, the end-group is thin. The hydrophilic group at the amphiphile tail is soluble in water, but insoluble in oil. The hydrophobic end-group repels water, but water interacts with the water-soluble hydrophilic group underneath, which is closer to the surface, so thermodynamically water is driven to be in intimate contact with the surface to maximize interaction with the water soluble part. Oil, however, doesn't like the oleophobic end-group, but has no driving force to be in contact with the hydrophilic part so remains on the end-group, which is presented on the top of the surface.

Water And Hexadecane Behavior on f-PEG Brushes

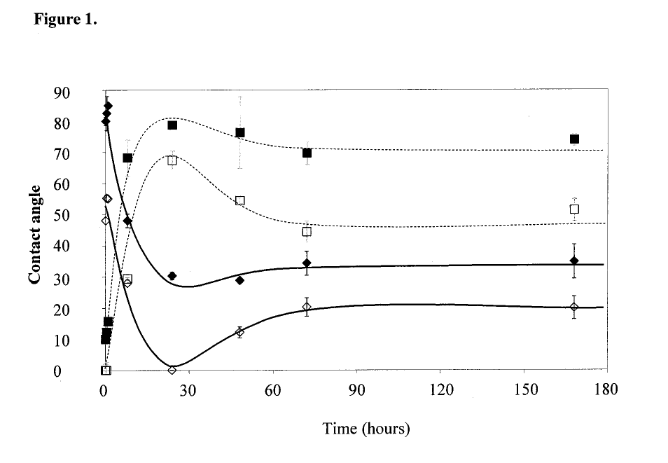

Polymeric chains of poly(ethylene glycol) (PEG) with short perfluorinated endcaps (f-PEG brushes) were tethered to silica surfaces using grafting-to techniques. Referring to FIG. 1, advancing and receding water angles, and advancing and receding hexadecane angles are shown as solid diamonds, empty diamonds, solid squares, and empty squares, respectively. Grafting reactions of f-PEG solutions with short reaction time (less than about 8 hours) exhibited traditional wetting responses similar to control surfaces with water contact angles being greater than hexadecane contact angles. After a critical reaction time, f-PEG brush surfaces began to show an increase in hexadecane contact angle and a decrease in the water contact angle. The shifts in wetting response were dramatic enough that hexadecane contact angle was higher than that of water. Optimized surfaces were obtained at intermediate reaction time (about 24 hours). These surfaces had water contact angles of about 30°/0° and hexadecane contact angles of about 79°/67°. The stimuli-responsive surfaces thus showed that the static hexadecane contact angles were greater than static water contact angles. That is, the receding contact angle of a low surface energy fluid (hexadecane) is greater than the advancing water contact angle.

The stimuli-responsive behavior of f-PEG brush surfaces was found to have a strong correlation with grafting density of the brushes. At grafting time of about 8 hours or less when the surface has not achieved full coverage of f-PEG in a mushroom conformation, the brushes had insufficient surface density to elicit stimuli-responsive behavior. As grafting reaction proceeded, the grafting density increased and surface coverage became complete with brush conformation transitioning to slightly elongated spheroids and subsequently an increase in measured film thickness. Further increasing grafting time produced thicker, denser layers. As the polymers became more elongated, the stimuli-responsiveness for f-PEG brushes decreased slightly.

Wettability switch is accomplished through the use of polymer brushes. The increased response time associated with the grafting-from based stimuli-responsive polymer brushes is mitigated by using very short chain polymers as brushes, effectively eliminating any delay in response time. Brush surfaces are created via grafting-to methods which attain an optimum performance at low brush density.

Thus, surfaces with covalently grafted perfluorinated end-capped PEG brushes were stimuli-responsive and simultaneously displayed PEG-like behavior to water and fluorinated behavior to oil (hexadecane). Brush densities were relatively low and in the mushroom regime. Some stimuli-responsive surfaces show optimal behavior at the transition from spheres to elongated spheroids, while denser layers with more elongation were detrimental to performance. Thus, short oligomeric chains at low packing densities may be superior to high density extended geometries. It may be that the free volume and relative ease-of-motion in dense spheroids allows for the faster switching kinetics, which promote the rearrangements necessary to minimize energetics while still providing for continuous coverage.

Instantaneous Solvent-Selective Stimuli-Responsive f-PEG Brush Surfaces

Surface character can be altered in order to induce a change in wetting behavior. Such systems manipulate the surface to change the contact angle response toward a common liquid. Water either wets or beads on the surface depending on the treatment history. The f-PEG brush surfaces behave quite differently, as water would always wet the f-PEG brushes and hexadecane was not observed to wet the f-PEG brushes.

Considering these behaviors, a situation exists where a droplet of oil with a higher contact angle than a droplet of water can exist on the same surface at the same time. Oil and water were added to the stimuli-responsive surfaces presenting f-PEG brushes. Sessile-drop contact angle response of oil and water existed simultaneously on the f-PEG brush surfaces. Once the stimuli-responsive surfaces were created, the stimuli-responsive behavior is stable and independent of solvent history. The f-PEG brush surfaces attained equilibrium contact angles much faster than the measurement technique employed, which is on the order of seconds. Reported solvent-responsive surfaces have shown time dependent behavior, requiring exposure to solvent between 30 and 60 minutes for optimum results. The novel f-PEG brush surfaces showed instantaneous solvent-selective stimuli-responsiveness requiring no pretreatment.

Self-Cleaning f-PEG Brush Surfaces

When considering anti-fouling surfaces or applications for soil-release, the receding contact angle of the foulant (hexadecane) should be higher than the advancing contact angle of the solvent (water), such that the solvent has a thermodynamic driving force to displace the foulant on the surface. That is, to remove a droplet of oil from a surface, the energy gained in creating water-substrate contact must be greater than the energy lost in losing oil-substrate contact. Due to the inherently low surface energy of foulants, systems exhibiting soil-release are rare. Most reported self-cleaning surfaces are superhydrophobic surfaces, where droplets of water that bead up to near 180° contact angles pick up dirt and carry it off of the surface with the rolling droplet. However, oils fouling the surface are more difficult to remove due to their low surface energy and thus a propensity to aggressively wet surfaces.

The novel f-PEG brush surfaces showed a thermodynamically self-cleaning surface where the receding contact angle of the oil (hexadecane) is higher than the advancing contact angle of the water so that water has a thermodynamic driving force to displace the oil on the surface. In one example, oil droplets were placed on a slide coated with the f-PEG polymer brushes, followed by water containing reddish-orange. With minimal mechanical agitation, water displaced the oil on the surface. Upon tilting the sample, the oil floated off and oil was removed from the slide. When oil was placed in contact with water on hydrophobized glass, f-PEG brush modified glass, and clean glass, the surfaces showed differing behaviors. Oil on hydrophobized glass, f-PEG brush modified glass, and clean glass was exposed to gently flowing water. Water displaced oil on f-PEG brush surfaces, while water remained on top of and did not de-wet oil on the other two surfaces.

When water containing reddish-orange was added to an f-PEG brush modified slide with oil droplets, the water was energetically driven to undercut the oil droplets, which, when displaced, freely floated on top of the water. As the glass slide was tilted, the oil was completely removed from the surface leaving behind only a thin wetting film of water. In comparison, on both hydrophobized fluorinated glass and hydrophilic clean glass, when water and oil were placed on the surface, water actually climbed on top of the oil layer, preventing the surface from being washed. While density of the respective fluids suggests that oil should float on water, surface energetics dictates otherwise as the low surface energy of oil prevents it from being displaced by water. Interfacial free energy is minimized when the surface has oil-water and oil-surface interfaces rather than oil-water and water-surface interfaces. This behavior shows that upon soft flowing water treatment, f-PEG brush surfaces are self-cleaning, while water fails to clean the surface and oil is retained on both hydrophobic fluorinated silica and hydrophilic clean glass.

Self-Cleaning f-PEG Copolymer Surfaces

Perfluorinated poly(ethylene glycol) were modified with methacryloyl chloride to create f-PEG monomers which were subsequently randomly copolymerized with various co-monomers to create bulk f-PEG copolymers with self-cleaning properties. Monomer feed ratios were varied across the compositional spectrum to establish minimum f-PEG content necessary to exhibit self-cleaning properties. Suitable co-monomers include, but are not limited to, acrylic acid (AA), hydroxyethyl methacrylate (HEMA), 4-vinyl pyridine (VP), and methyl methacrylate (MMA), with the goal of determining the best co-monomer with respect to self-cleaning ability and anti-fog ability. Solubility was used as a third design criteria as hydrophilic coatings which water soluble can suffer from a short lifetime and are poor candidates for self-cleaning coatings.

Polymer performance was characterized with respect to solubility, as it was expected that the introduction of surfactant moieties would potentially render some compositions to be mildly water soluble. Notably, while poly(acrylic acid) (PAA) is itself water soluble, the addition of f-PEG constituents into the bulk polymer resulted in non-water soluble polymers. For both HEMA and PAA based polymers, small amounts of surfactant (more than about 10%) resulted in solubility at elevated pH. Likewise, HEMA and PAA based polymers will be soluble in ethanol regardless of composition, and in acidic isopropyl alcohol. The solubility characteristics of the polymers are of extreme importance with regard to their potential applications as surface coatings. Polymers which are susceptible to dissolution in aqueous environments potentially suffer from short lifetimes as a coating, and their use may be enhanced through covalent surface attachment or by adjusting solubility characteristics.

The self cleaning ability of the f-PEG copolymers was assessed by measuring the water contact angle and the hexadecane contact angle on surfaces which has been spin cast from solution. Hexadecane was used as a representative foulant, as it has very low surface energy and is prone to aggressively wet surfaces. Additionally, because water has a much higher surface energy, and no affinity for hexadecane, water will not clean hexadecane on traditional surface.

The criteria for self-cleaning requires that the contact angle of the foulant (hexadecane) is greater than the contact angle of water, which is the “cleaning” fluid. In the event that this is true, water has an energetic driving force to displace the foulant on the surface, as the water will more aggressively wet the surface. Advancing and receding contact angles for water and hexadecane are summarized for f-PEG copolymers (about 10% feed ratio) in Table 1. Examples of f-PEG groups include, but are not limited to, FSN and FSO from DuPont. While f-PEG-PMMA copolymers have an elevated hexadecane contact angle as compared to neat PMMA on which hexadecane spreads, these surfaces were not self-cleaning. However, for both f-PEG modified HEMA, VP, and PAA bulk copolymers, the hexadecane contact angle is greatly enhanced, while maintaining hydrophilicity. Therefore, these polymer types could potentially be used in self-cleaning applications.

TABLE 1
Dynamic Contact Angle for Various f-PEG Based
Copolymers at about 10% f-PEG Feed Ratio

| Sample | Adv/Rec^{(water)} | Adv/Rec^{(hex)} |
|---|---|---|
| FSO PMMA | 84°/63° | 30°/10° |
| FSN PMMA | 83°/64° | 30°/8° |
| FSO HEMA | 33°/0° | 60°/20° |
| FSN HEMA | 30°/0° | 64°/20° |
| FSO PAA | 42°/0° | 70°/33° |
| FSN PAA | 45°/0° | 80°/33° |
| FSN VP | 16°/0° | 71°/60° |

Non-Fouling Anti-Fog f-PEG Brush Coatings

One place where oil-repellent, yet hydrophilic, surfaces can have great impact is in anti-fog coatings. An advancing water contact angle of less than about 40° has been experimentally established as a critical threshold to prevent fogging on surfaces. Surfaces with advancing water contact angles greater than about 40° will result in moisture condensing in discrete droplets on the surface which scatter light creating a translucent fog. On the other hand, if a surface is highly wettable, the moisture will form a continuous thin film which is transparent. The unique wetting characteristics of the f-PEG brushes suggest their application as non-fouling anti-fog coatings. The f-PEG brushes have been shown to be highly wettable by water, and are able to mitigate the formation of a fogged surface, yet the surfaces maintain oleophobic behavior thus preventing fouling by oily substances.

Fogging of various surfaces in response to being held over boiling water was studied. The surfaces include hydrophobized glass, optimized f-PEG brush surfaces, and clean glass. The f-PEG brush surfaces had no fogging, the cleaned glass had some fogging and the fluorinated hydrophobized glass had a very visible fog layer. The f-PEG brush surfaces were able to both prevent fogging and simultaneously be oleophobic. Many anti-fog coatings are ruined when fouled with oils (such as residue left from fingerprints) as the low surface energy of oils renders them difficult to be completely cleaned from the surfaces and they create a new surface which will induce fogging rather than prevent it. Moisture will bead up on anti-fog coatings fouled with oil. In this manner, even the glass cleaned with piranha solution can fog. In the approximate hour after cleaning, the silica has enough adventitious oils to promote fogging. In the f-PEG brush materials, it is possible for surfaces to be simultaneously anti-fog and oil-repellant. Even if f-PEG brush anti-fog coatings are exposed to oils, the foulant can be easily removed to maintain the anti-fog character.

Optimal performance of anti-fogging coatings can be obtained by coating surfaces with water swellable and porous materials. Such materials as layer-by-layer deposited films can act as reservoirs that can absorb extra water, preventing buildup of droplets on the surface. Regardless, brush-like systems work on their own and, overall, this class of materials has a wide range of potential applications including, but not limited to, anti-fog coatings in lenses, mirrors, and windows. Furthermore, f-PEG brushes could be employed in systems which require soil release such that the surface will prevent fouling by oils, while still maintaining the ability for water to wet the surface, thus promoting surfactant-free environmentally benign self-cleaning of other adherents.

The unique wetting characteristics of the f-PEG brushes allow their application as non-fouling anti-fog coatings as they are both highly wettable by water, able to mitigate the formation of a fogged surface, and maintain oleophobic behavior, thus preventing fouling by oily substances. Even if the f-PEG anti-fog coatings are exposed to oils, the self-cleaning nature of the surfaces allows the foulant to be easily removed by immersion in water to recover the anti-fog character. In this way, these surfaces are potentially suitable for long-lasting, self-cleaning anti-fog coatings.

Non-Fouling Anti-Fog f-PEG Copolymer Coatings

The hydrophilic f-PEG copolymers similarly have a potential application as anti-fog surfaces. Fog will not develop on hydrophilic surfaces, as the water condensed and wets the surface forming a transparent sheet as opposed to discrete droplets which scatter light. Anti-fog surfaces that are oleophobic are useful, as contaminates will ruin the hydrophilicity of a coating and cause it to again fog in the presence of condensate. The spin cast surfaces were tested for fogging in two environments: held above steam bath and removed from −20° freezer into humid laboratory air. Acrylic acid based copolymers performed the best in both tests showing no fogging in either case. HEMA based polymers were prone to fogging, however, which was surprising as their measured contact angles were lower than those of the f-PEG-PAA copolymers. Polyacrylic acid-co-methacryloyl-f-PEG (10%) was deposited from a basic solution onto a mirror glass. For comparison the remainder of the mirror glass was cleaned with basic solution containing no copolymer. The mirror glass was exposed to saturated water vapor. The copolymer coated glass did not fog, whereas the unmodified glass showed significant fogging. The fogging test was aggressive enough to result in macroscopic condensation on the modified glass; however, clear vision was still maintained.

Separation of Oil-in-Water Emulsions Using f-PEG Brush Modified Membranes

Water droplets were placed in contact with stable hexadecane droplets on f-PEG brush modified filters. The water droplet displaced the hexadecane droplet on the surface and proceeded to infiltrate the pores. Once the hexadecane droplet again reached the surface, it remained stable, though with a lower contact angle.

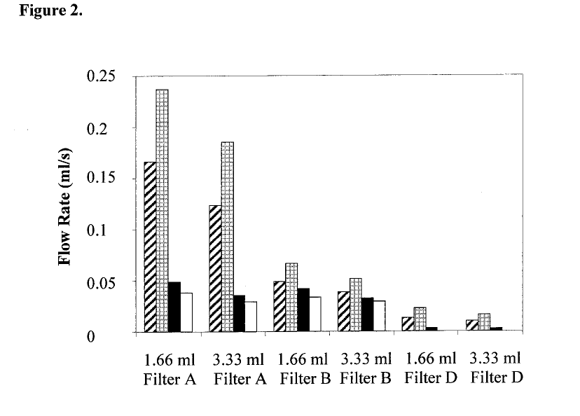

Referring to FIG. 2, bulk flow rates of water and hexadecane through unmodified membranes and f-PEG brush modified membranes were studied. Diagonally hatched boxes are water through unmodified membranes; square hatched boxes are water through f-PEG brush modified membranes. Solid black boxes are hexadecane through unmodified membranes; solid white boxes are hexadecane through f-PEG brush modified membranes. Modified filters demonstrated enhanced water flow rates as compared to control filters of corresponding pore size. Conversely, the f-PEG brush modified filters demonstrated retardation in hexadecane flow rate as compared to the corresponding control filters with filter type D completely preventing the flow of hexadecane. Bulk flow rates were strongly dependant on pore size, with the largest pore filters having the greatest flow rates. The decrease in flow rate between the about 1.66 mL and the about 3.33 mL volumes is expected due to the continuous reduction in fluid pressure as the column of fluid decreases in volume. Unmodified filters were used as controls. Individual droplets of both hexadecane and water passed through unmodified filters immediately. Flow rate for bulk amounts of water and hexadecane were measured. Water flow rate was strongly dependant on pore size. Hexadecane flow rate was not significantly dependant on pore size for modified filters, but was pore size dependant for the f-PEG brush unmodified filters.

In some embodiments, water and hexadecane droplets dispensed from an automated syringe tip were placed on modified and control membranes. Both fluids wet the surface of the unmodified control membranes and disappeared into the pores before any measurement could be acquired. This result is in agreement with the wetting behavior of both fluids on clean silica. Water also substantially completely wet the modified ˜145-174 μm (A) and ˜70-100 μm (B) membranes before a true contact angle could be measured. Static water contact angle of ˜30.3° was measured on modified ˜10-20 μm D membranes; however, after a short amount of time the water droplet substantially completely infiltrated the pores. The variation in water contact angle of the three membranes may be attributed to differences in pore diameter.

In contrast to the water contact angles, static hexadecane contact angles on modified membranes were higher than unmodified membranes on all three membrane sizes: hexadecane contact angles of about 48°, 51°, and 105° were measured on A, B, and D membranes, respectively (Table 2). Hexadecane contact angles on A and B membranes were slightly below that of f-PEG modified flat silica slides, while the hexadecane contact angle on the D membrane was enhanced over modified flat substrates. The enhancement of the hexadecane contact angle for the modified D membranes is likely due to the increased surface roughness at the surface acting as a barrier to wetting. The pores on the D membranes are small enough that the non-wetting hexadecane cannot infiltrate the pores and the fluid becomes pinned at the pore edges, thus enhancing the measured static contact angle as compared to a flat f-PEG modified surface. The hexadecane droplet on the modified D membrane remained stable overnight and did not penetrate the surface of the membrane unlike the A and B membranes, which had full permeation of hexadecane droplets in air within about 30 minutes of the drop being placed on the membrane surface.

TABLE 2
Mass Percent Of Hexadecane Collected In
Permeate From Oil-In-Water Suspensions.

| | Pore | Mass % | Water | Hexadecane |
|---|---|---|---|---|
| | size | hexadecane | contact | contact |
| Filter type | (μm) | in permeate | angle | angle |
| Filter A unmodified | 145-174 | 98.0 | Wetting | Wetting |
| Filter A f-PEG | 145-174 | 4.5 | Wetting | 48° |
| Filter B unmodified | 70-100 | 90.6 | Wetting | Wetting |
| Filter B f-PEG | 70-100 | 5.2 | Wetting | 51° |
| Filter D unmodified | 10-20 | 97.7 | Wetting | Wetting |
| Filter D f-PEG | 10-20 | 2.6 | 30° | 105° |

Uncertainty In The Selectivity Measurements Is ±1.2%.

Hexadecane contact angles were measured for f-PEG modified and control membranes submerged in water by forcing the hexadecane droplet from the syringe onto the membrane. This method was used as after measurement of contact angle, the drops were observed for “sticking” or “displacement behavior.” Unmodified membranes had hexadecane contact angles >˜90°. However, even with a high contact angle, sticking behavior of the hexadecane droplet to the submerged membrane was observed, as after the needle was removed from the droplet, it remained attached to the membrane. Membranes modified with f-PEG had hexadecane contact angles >˜140°, and the hexadecane droplets were not stable on the submerged surfaces, being displaced by water after needle removal.

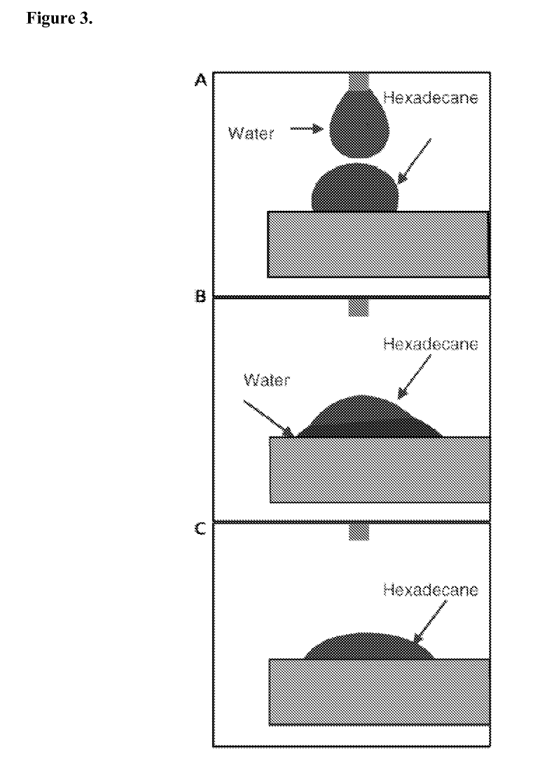

Referring to FIG. 3, single water droplets were placed in contact with single stable hexadecane droplets on modified membranes. (This particular experiment could not be performed on the unmodified membranes as droplets of both fluids immediately pass through the membrane surface.) Upon contact, the water droplet displaced the hexadecane droplet on the surface and proceeded to infiltrate the pores. Once the hexadecane droplet again reached the surface, it remained stable, though with a lower static contact angle. The displacement of the hexadecane droplet on the membrane surface is analogous to the anti-fouling behavior observed on flat f-PEG modified surfaces. The hexadecane droplet spreads out further when its interface is the water droplet. Thus, the hexadecane “footprint” expands as compared to when its interface begins on the membrane. Once the water passes fully into the membrane pores, the expanded “footprint” remained resulting in a lower observed static contact angle. However, the hexadecane droplet remained stable on the membrane surface and did not pass into the pores.

The behavior of water and hexadecane on the f-PEG modified membrane is counter to typical oil-water behavior on surfaces. When in the bulk state, oil (hexadecane included) will float on top of water due to density differences, as is commonly observed with environmental oil-spills or the film of grease which floats on water in the kitchen sink. When the two fluids are in contact with a solid surface, the effects of surface energy dominate the behavior; as such, the oil will aggressively wet the surface as the system seeks to minimize interfacial energy, displacing the water in spite of the fact that fluid density alone would dictate otherwise. It is for this reason that oils are an especially difficult foulant to control, as traditional surfaces, whether high or low energy, can be more readily wetted by oils than by water.

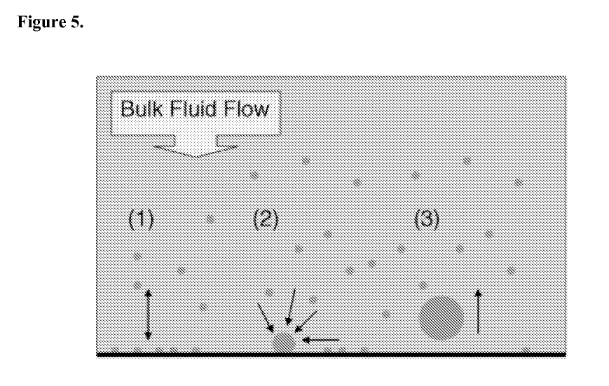

Referring to FIG. 5, membrane permeability (L/min/m²/Torr) scaled with pore size regardless of fluid or treatment type. Unmodified control membranes exhibited water and hexadecane permeability that was not significantly different for A and B membranes. Water permeability was significantly higher than hexadecane permeability for D membranes. Modified membranes had significantly lower permeability for both water and hexadecane when compared to unmodified membranes of the same pore size. Additionally, the modified B and D membranes had significant retardation of hexadecane permeability as compared to water permeability. The differences in permeability of the two fluids was not significant for the modified A membranes. As indicated by the ellipsometry characterization of flat f-PEG surfaces, a fully dense f-PEG layer does not exceed a thickness of about 5 nm. Thus the presence of f-PEG should not significantly affect the permeability of the pores based on a physical reduction in pore diameter. Therefore, the enhancement of the difference in permeability of water and hexadecane is likely due to the chemical nature of the f-PEG surface.

The ability of modified membranes to separate hexadecane suspended in water was measured. Aliquots of the stable oil-in-water emulsions were passed through the membranes with no pressure differential across the membrane. Control membranes permitted greater than about 90% of the hexadecane to permeate for all pore sizes; creaming of the emulsion was not observed in the column, the permeate did however contain coalesced hexadecane. Modified membranes, regardless of pore size, permitted less than about 6% of the hexadecane introduced to the column from passing through the membrane, as shown in Table 2. Due to the high static contact angle of hexadecane on the modified membrane surface, when the membranes were flushed with pure water, the macroscopic hexadecane on the membrane was displaced from the surface and still did not pass through the membrane. Once the modified membranes were wetted with water, they acted as a chemical gate, disallowing the passage of hexadecane while still permitting water to pass.

The pore size and fiber contact area has an effect on the efficiency of the coalescence mechanism. Membranes with a large pore size are more likely to permit small dispersed droplets to permeate the membrane unimpeded. The D membranes have a greater surface area on which coalescence may occur. This results in an increase in selectivity at the expense of overall flow rate.

Referring to FIG. 5, not wishing to be bound by any theory, it is noted that the mechanism of hexadecane exclusion differs from many typical coalescence membrane systems. Conventional coalescence membranes have three primary steps: capture of the dispersed droplet, coalescence of the droplet at the membranes surface, and passage of the coalesced fluid through the membrane. With conventional membranes the coalesced fluid is captured as part of the permeate fluid and a subsequent separation step is introduced. The process of coalescence for the f-PEG modified membranes is similar through the first two steps. Dispersed hexadecane is captured at the membrane surface. As the surface density of captured hexadecane droplets increases, droplets begin to coalesce. However, f-PEG modified surfaces with anomalous wetting characteristics, where water wets the surface preferentially over oil, show self-cleaning or easy-to-rinse behavior. If a surface with oil on it is then placed in contact with water, the oil is released from the surface and floats on top of the water. This behavior is not observed for either hydrophobic or hydrophilic surfaces, but only oleophobic, hydrophilic surfaces. Thus, the nature of the f-PEG membrane promotes water to displace the coalesced hexadecane and release it from the membrane surface. Upon release, the hexadecane, which has a lower fluid density, rises to the top of the pre-filtered dispersion.

Silica surfaces modified with perfluorinated polyethylene glycol have simultaneously demonstrated hydrophilic wetting behavior with respect to water and oil-repellence with respect to hexadecane. This system was applied to silica membranes for the purpose of selectively separating oil-in-water suspensions. For f-PEG membranes, hexadecane permeability was retarded to a greater extent than was the reduction in water permeability. Membranes were effective in inducing the coalescence of dispersed hexadecane and preventing subsequent permeation. Reducing the pore size of the modified membranes negatively affected the permeability; however pore size reduction enhanced the membrane selectivity. Hexadecane coalescence and membrane selectivity was due primarily to the alteration of the membrane surface chemistry as water was able to preferentially displace hexadecane on modified surfaces. The pore size did have some effect on the selectivity, with the D membrane being twice as selective as the B membrane. Finally, it is notable that hexadecane selectivity was achieved with microfiltration membranes. The fact that there was very little difference in the measured hexadecane contact angles, and very little difference in the fluid selectivity when comparing the A and B membranes indicates that the oil-repellent character of the modified membranes is scarcely sensitive to pore size. In this manner, the gains in water permeability with the larger pores can be taken advantage of without the downside of sacrificing selectivity to foulants.

### EXAMPLES

1. Materials. Glass fiber filter discs of three different pore sizes were purchased from Ace Glass. Discs were 8 mm in diameter and pore sizes were rated as 145-174 μm (A), 70-100 μm (B), and 10-20 μm (D). Glass tubing, 8 mm inner diameter, was also purchased from Ace Glass. Perfluorinated surfactants (f-PEG) were purchased from DuPont (Zonyl %) FSN-100 and Zonyl FSO). Zonyl %) FSN has a reported molecular weight of about 950 g/mol. The Zonyl %) molecule was characterized by DuPont as F(CF₂CF₂)_{y}CH₂CH₂—O—(CH₂CH₂O)ₓH where y ranges from about 1-7 and x ranges from about 0-15. Based on the reported molecular weights, FSN was estimated as being primarily y=5 and x=9. Zonyl FSO has a reported molecular weight of about 725 g/mol. Perfluorinated surfactants were dried using MgSO₄ in anhydrous toluene in a sealed nitrogen environment. The following monomers were purchased from Sigma-Aldrich and were purified using trap-to-trap distillation: methacryloyl chloride, methyl methacrylate, hydroxyethyl methacrylate, acrylic acid. 3-isocyanatopropyldimethylchlorosilane (ICPDS), 3-isocyanatopropyldimethylchlorosilane (ICPDMS), and (tridecafluoro-1,1,2,2-tetrahydrooctyl)dimethylchlorosilane were purchased from Gelest, Inc. (Morrisville, USA) and used as received. Anhydrous toluene, trifluorotoluene, MgSO₄, hexadecane, polyethylene glycol, methanol, hexane, chloroform, ethylene glycol dimethacrylate, 2,2′-azobisisobutyronitrile (AIBN), hydrogen peroxide and sulfuric acid were purchased from Sigma-Aldrich Co. (Milwaukee, USA) and used as received. Water was deionized in-house to a resistivity of 18.3 MΩ using a Barnstead Nanopure Infinity filtration system.

2. Surface Modification. Silicon wafers were cut into about 1 cm square slides and cleaned by immersion in piranha solution (about 2:1 sulfuric acid to hydrogen peroxide) for about 30 minutes. Slides were thoroughly rinsed in DI water and dried under vacuum. Slides were immersed for about 24 hours in a about 33% (by volume) solution of ICPDMS in anhydrous toluene. Reaction conditions were based on the kinetics of formation of alkyltrichlorosilane self assembled monolayers. The isocyanate-modified surfaces were exposed to MgSO₄-dried f-PEG solutions of about 0.1 molar in anhydrous toluene ranging from about 5 minutes to about 168 hours at room temperature in order to determine optimal surface coverage.

The chlorosilane group of the ICPDMS molecule reacts with silica forming a covalent bond with the surface. The resulting isocyanate surface is reactive toward the terminating alcohol group on the PEG constituent of the f-PEG brushes. Due to the high reactivity of isocyanates, both grafting steps were performed sequentially in a closed vessel to prevent fouling by air or humidity or excessive handling.

After f-PEG brush treatment, slides were rinsed under flowing toluene, methanol, and DI water, and dried under vacuum before characterization. The following surfaces were used as controls: clean silicon wafer, silicon modified with isocyanate layer, silicon wafer with adsorbed f-PEG brushes (no isocyanate), f-PEG brush coated silicon wafer, fluorinated silicon wafer. All surfaces containing urethane linkages were unaffected by repeated rinsing. The f-PEG brush surfaces without urethane linkages eventually dissolved upon repeated rinsing.

For silica filters, f-PEG brushes were dried using MgSO₄ in anhydrous toluene in a sealed nitrogen environment. Fritted glass filters of three different pore sizes were purchased from Ace Glass. Filters were cleaned by immersion in piranha solution (about 2:1 sulfuric acid to hydrogen peroxide) for about 30 minutes. Filters were initially placed under slight vacuum to promote full infiltration of the piranha solution throughout the entire filter. Filters were thoroughly rinsed in DI water and dried under vacuum. Filters were immersed for about 24 hours in an about 33% (by volume) solution of ICPDMS in anhydrous toluene. Reaction conditions were based on the kinetics of formation of alkyltrichlorosilane self-assembled monolayers. The isocyanate-modified surfaces were exposed to MgSO₄-dried perfluorinated surfactant solutions of about 0.1 molar in anhydrous toluene for about 24 hours at room temperature. Similar to the cleaning method, the grafting steps were temporarily exposed to slight vacuum in an attempt to achieve a fully modified filter. Silica surfaces were also modified in this way as a control system. After the final grafting step, filters were placed in toluene, methanol and water sequentially to rinse residual surfactant. Each rinse solvent was infiltrated under slight vacuum. After the water rinse, filters were dried under vacuum.

3. Characterization Techniques. Dynamic water and hexadecane contact angle measurements were taken using a Ramé-Hart Advanced Automated Model 500 goniometer. Filter wettability was measured in at least three locations on a dry surface for each fluid type and pore size. X-ray photoelectron spectroscopy (XPS) was performed on a Kratos Axis Ultra spectrometer using monochromatized Al Kα radiation at about 1486.6 eV. XPS beam angles of about 15° and about 75° to normal were used to differentiate the relative depth of each element in the substrate. Ellipsometry measurements were taken on a Gaertner L116S Variable Angle Stokes Ellipsometer. Proton NMR spectra were measured using a Varian Inova300-1. Molecular weight distributions for methyl methacrylate and hydroxyethyl methacrylate based copolymers were measured using a Polymer Laboratories PL-GPC 20 GPC.

For bulk fluid measurements of silica filters, a short segment of tubing (8 mm ID) was attached to each filter using Duco Cement. Upon drying, the filters and tubes were checked for leaks around the seal, ensuring that all fluid flow occurred through the modified filter. Glass tubes were marked at three volume levels: about 1.66 mL, about 3.33 mL, and about 5.00 mL. Flow rates were measured in the laboratory environment (atmospheric pressure). Dry tubes were filled with an excess of about 5 mL of water and flow rate was measured across two volume changes. Elution rate was measured beginning when the water level passed the about 5 mL marker and measurements were taken for the first about 1.66 mL to pass and for the first about 3.33 mL to pass. Due to the ability of the filter pores to retain a significant volume of fluid, the flow rate for the final 1.66 ml was not measured. After measuring flow rates for water, tubes and filters were dried under vacuum and measurements were recorded for hexadecane flow rate.

Water-hexadecane emulsions were tested using the same filter-tube apparatus. Emulsions were created by rapidly forcing an about 15:1 volume ratio of hexadecane to water through a 26 gauge needle. Emulsions were injected directly into the filter-tube apparatus. Stability of the emulsion was monitored by observing an equivalent emulsion in a vial over the course of the experiment. The resultant fluid which passed through the filter was collected in a pre-weighed vial. Residual hexadecane was isolated in the vial by allowing the water to evaporate overnight. Residual hexadecane was then weighed to determine the percentage of hexadecane which had been retained by the filter. Clean, unmodified filters of equivalent pore sizes were used as controls for each characterization step.

For membranes, glass tubes were placed in a custom flask attached to a vacuum aspirator (Boekel). Pressure across the membrane was regulated with a digital vacuum regulator (J-KEM Scientific). The pressure for each membrane was chosen such that 5 mL of water would pass through an unmodified membrane between 10 and 20 seconds. The change in pressure across the membranes was 25 Torr for (A) membranes, 45 Torr for (B) membranes, and 300 Torr for (D) membranes. After measuring flow rates for water, tubes and membranes were dried under vacuum and measurements were recorded for hexadecane flow rate.

Modified membranes were tested for selectivity in their ability to separate water-hexadecane emulsions. The same membrane-tube apparatus was used in selectivity tests. However, in contrast to the pure water and hexadecane permeability test, no pressure differential was applied across the membrane; rather, the emulsions were gravity fed through the membrane. Surfactant free oil-in-water emulsions can be created through a variety of methods including sonication, freeze-pump-thaw cycles, or mechanical mixing. The stability of the oil-in-water emulsions is strongly affected by the chain length of the oil. Surfactant free hexadecane-in-water emulsions have been shown to be stable for longer than 24 h as compared to similar suspensions of decane-in-water which were only stable ˜3 h. Surfactant free oil-in-water emulsions were created by mechanically nebulizing a mixture of water and hexadecane, 2:1 by volume, through a 26 gauge needle. Emulsions were allowed to settle for ˜30 min as macroscopic hexadecane physically separated and rose to the top of the emulsion.

The stability of the emulsion was observed visually over a 24 h period, which was much longer than the time needed for the membrane experiments; the mixture maintained a cloudy, turbid appearance indicating that the emulsion remained intact. The mechanically dispersed emulsions had hexadecane particles on the order of ˜10 μm in diameter. The mass percent of dispersed hexadecane in the emulsion was measured by removing 1 mL aliquots of the stable emulsion and allowing the water to evaporate on a microscope slide. The remaining hexadecane was massed.

The final volume ratio of the emulsions sampled for separation testing was ˜12:1 water to hexadecane based on the residual mass measurements and the densities of the two fluids.

Stable emulsions were injected directly into the membrane-tube apparatus. The resultant fluid which passed through the membrane was collected in a pre-weighed vial. Residual hexadecane was isolated in the vial by allowing the water to evaporate overnight. Residual hexadecane was then weighed to determine the percentage of hexadecane which had been retained by the membrane.

4. Dynamic Contact Angle. Contact angles were measured within about 1 minute of fluid contact, over the course of about 10 minutes static contact angles did not change. Supplemental measurements were taken three months after initial contact angle measurements, with no loss in stimuli-responsiveness.

Contact angles were measured on control surfaces of PEG brushes and fluorinated chlorosilanes grafted onto silicon. Water and hexadecane both spread readily on PEG. Advancing and receding water contact angles of about 120°/112° were measured on the fluorinated surface. Advancing and receding hexadecane contact angles of about 95°/35° were also measured on the fluorinated surface. As can be seen by the control experiments, hexadecane will have a contact angle lower than water on traditional surfaces due to the lower surface energy of hexadecane.

The three phase contact angle, as described by Young's equation, is determined by balancing the surface energy of the solid/vapor (s/v), solid/liquid (s/l), and liquid/vapor (1/v) interfaces. For a substrate and liquid of equivalent surface energy, the s/v and s/l vectors are of equal length and opposite direction resulting in an about 90° contact angle. As the surface energy of the liquid is reduced, the s/l vector decreases, which lowers the contact angle allowing the liquid to wet the substrate. A liquid of higher surface energy will increase the s/l vector resulting in a higher contact angle; in this case the liquid does not wet the surface.

5. Ellipsometry. Refractive index was estimated at about 1.42 for the f-PEG brushes. The estimate was determined using about 1.46 as the refractive index of PEG and about 1.34 as the refractive index of polytetrafluoroethylene and applying a “rule-of-mixtures” method based on the stoichiometric ratios of the f-PEG constituents previously stated in the Methods section. The f-PEG brush was estimated to have an end-to-end chain length of about 59 Å and a radius of gyration of about 5.8 Å, also based on the stoichiometric ratios of the constituent groups.

6. Polymer Synthesis. Methacryloyl chloride in slight excess was reacted with dried f-PEG in anhydrous toluene overnight to create f-PEG monomer. The resultant monomer solution was purified using flash chromatography with methanol as a diluent. Bulk polymers of pure f-PEG were synthesized in toluene at about 70° C. stirring overnight with AIBN as the initiator. To create hydrogels, ethylene glycol dimethacrylate was added as a crosslinking agent. The molar ratio of crosslinking agent to monomer was varied between about zero (no crosslinking agent) to about 1:1. Hydrogels were also synthesized in various solvents (toluene, water) to create swollen networks. Solvent percentage varied from about 0 to about 10% by volume.

Random copolymers were synthesized from feed mixtures of f-PEG and acrylic acid, methyl methacrylate, or hydroxyethyl methacrylate with feed ratios ranging from about 1-99 mol % to about 50-50 mol %. Acrylic acid (PAA) based copolymers were synthesized in methanol and precipitated in toluene. Methyl methacrylate (PMMA) based copolymers were synthesized in toluene and precipitated in hexane. Hydroxymethyl methacrylate (HEMA) based polymers were synthesized in methanol and precipitated in chloroform. All polymers were synthesized in about 1:1 volume ratio of monomer to solvent at about 70° C. with AIBN as the initiator.

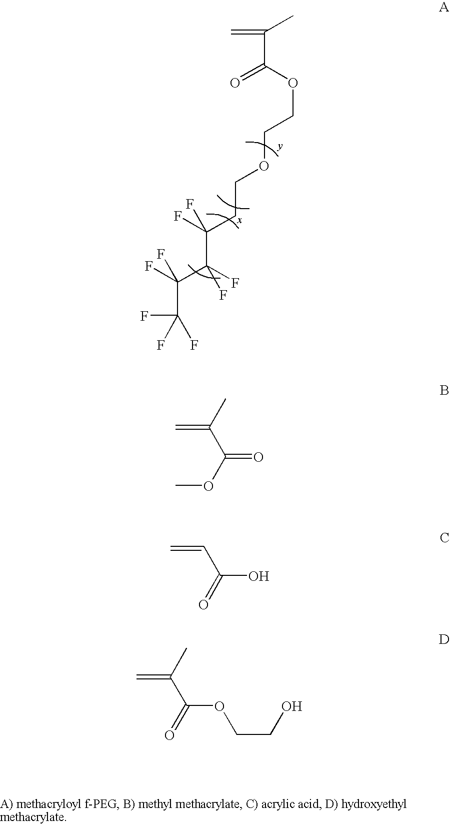

NMR spectra of the f-PEG monomers confirmed the successful reaction of methacryloyl chloride with the terminal alcohol group of the initial f-PEG molecule. Furthermore, NMR was used to determine final constituent ratios of each comonomer as compared to the respective feed ratio. GPC was used to characterize the molecular weight of HEMA and PMMA based polymers. Molecular weight of PAA based polymers was not characterized as they were incompatible with the GPC columns.

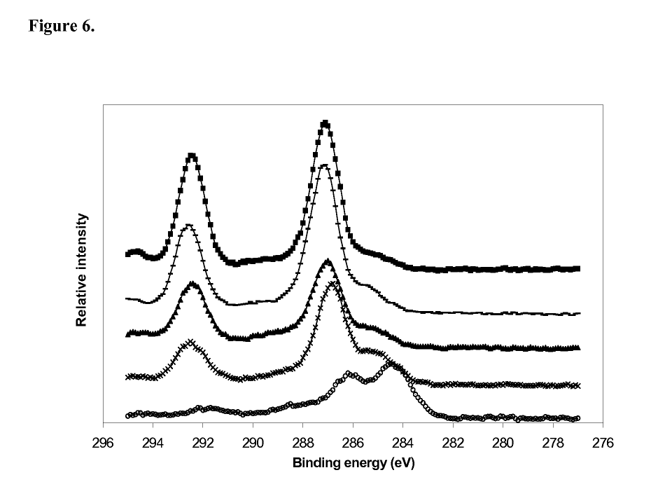

7. Characterization of f-PEG Surfaces. Referring to FIG. 6, evolution of the carbon signal for 75° XPS scans of f-PEG brush surfaces was determined. Surfaces exposed for about 72 hours (solid square), about 48 hours (dash), about 24 hours (solid triangle), about 8 hours (X), and about 1 hour (empty circle) are presented from top to bottom. Three distinct peaks are present at binding energies of about 284.3, about 286.7, and about 292 eV representing carbon signals from aliphatic carbon, PEG, and polytetrafluoroethylene, respectively.

Ellipsometry was used to determine brush thickness, which is an indirect indicator of grafting density. Brush thicknesses were consistently measured at about 18 Å for optimized surfaces. Measured thicknesses were larger than twice the calculated radii of gyration for f-PEG brushes (about 5.8 Å) but considerably shorter than the calculated elongated chain length (about 59 Å). Therefore, optimized surfaces were likely composed of brushes constrained into dense elongated spheroids—a football-like shape. Measurements showed thicker layers at longer reaction times indicating more elongated structures. The f-PEG brushes were measured to be about 45 Å thick for grafting reactions lasting about 72 hours or longer. However, extended brush thicknesses were never attained. XPS results support this argument as the carbon signal at about 285.5 eV decreases monotonically with reaction time. Thus, this signal may correspond to the ICPTMS underlayer that is losing intensity relative to the other peaks as the layer thickness increases.

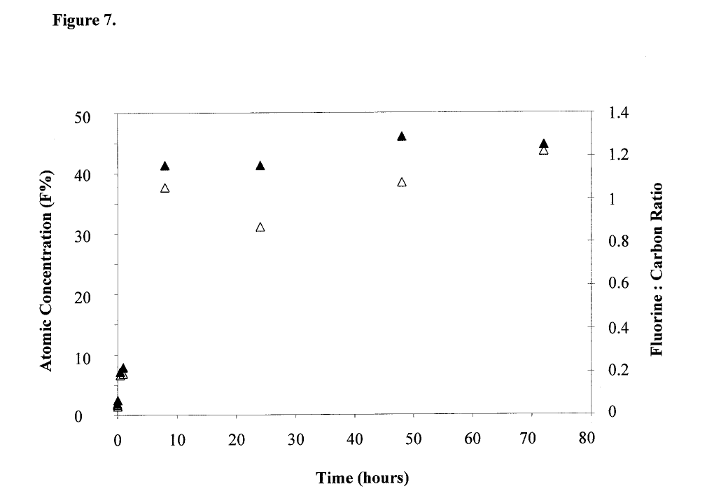

Referring to FIG. 7, XPS analysis of fluorine content in f-PEG brushes was reported. Atomic percentages of fluorine for f-PEG brush surfaces (solid triangle) with up to about 72 hours of exposure to f-PEG solutions were presented along the primary y-axis. The fluorine to carbon ratio as measured from the same scans was presented on the secondary y-axis for FSN (empty triangle). Measurements were taken at about 15° take-off angle. High resolution XPS showed fluorine content increased as reaction time increased and reached a plateau at about 40 atomic %. The F:C ratio for the stimuli-responsive surfaces was about 1 when measured at glancing XPS beam angle, indicating that some of the PEG constituent was being probed and that the layer was likely in the mushroom/elongated-spheroid regime. If the layer was brush-like and extended, the probed region would have a ratio of about 2, indicating just the perfluorinated constituent was being probed.

Oxygen was at a minimum for about 15° scans as compared to about 75°, indicating that there was also preferential segregation of the perfluorinated constituent to the surface (Table 3). However, the fluorinated constituent was not dense enough to fully mask the signal from the PEG constituent as evidenced by the high (about 13%) oxygen signal, lending credence to the argument of mushroom-regime behavior. The presence of silicon at about 75° showed that the surface had a large degree of holes in the structure, most likely due to self-exclusion (inherent with grafting-to method), further indicating a mushroom structure.

TABLE 3
A Five Element Summary of Quantitative XPS Analysis.

| XPS | | | | | | |
|---|---|---|---|---|---|---|
| Angle | FSN Exposure Time | F % | C % | O % | Si % | N % |
| 15 | 0 Hour | 1.9 | 39.6 | 29.0 | 23.4 | 6.1 |
| | 1 Hour (submonolayer) | 7.2 | 38.8 | 29.1 | 23.6 | 1.4 |
| | 24 Hours (optimized) | 41.3 | 47.4 | 6.3 | 3.4 | 1.6 |
| | 72 Hours (post-optimized) | 44.7 | 36.6 | 14.0 | 4.8 | 0.0 |
| 75 | 0 Hour | 1.0 | 19.3 | 31.2 | 46.2 | 2.3 |
| | 1 Hour (submonolayer) | 5.4 | 20.8 | 31.1 | 41.3 | 1.4 |
| | 24 Hours (optimized) | 38.6 | 37.3 | 12.3 | 11.4 | 0.4 |
| | 72 Hours (post-optimized) | 43.5 | 33.3 | 13.6 | 9.4 | 0.2 |

While the invention has been described with reference to certain embodiments, other features may be included without departing from the spirit and scope of the invention. It is therefore intended that the foregoing detailed description be regarded as illustrative rather than limiting, and that it be understood that it is the following claims, including all equivalents, that are intended to define the spirit and scope of this invention.

1. A copolymer comprising:
a first monomer including a hydrophilic group and a hydrophobic group linked to the hydrophilic group; and
a second monomer polymerized to the first monomer,
wherein the hydrophobic group is oil-repellant, and
wherein a receding contact angle of a low surface energy fluid on the copolymer is greater than an advancing contact angle of a high surface energy fluid on the copolymer.

2. The copolymer of claim 1, wherein the hydrophilic group is selected from a group consisting of poly(ethylene glycol), poly(vinyl alcohol), poly(acrylic acid), poly(methacrylic acid), and poly(vinyl pyrrolidone).

3. The copolymer of claim 1, wherein the hydrophobic group is selected from a group consisting of a fluorinated group, hydrophobic siloxane, and an alkyl group.

4. The copolymer of claim 1, wherein the first monomer further comprises a methacrylate group, which is polymerized to the second monomer.

5. The copolymer of claim 1, wherein the first monomer is poly(ethylene glycol) modified by a fluorinated group and a methacrylate group.

6. The copolymer of claim 1, wherein the second monomer is selected form a group consisting of acrylic acid, methyl methacrylate, 4-vinyl pyridine, and hydroxyethyl methacrylate.

7. The copolymer of claim 1, which is substantially not water soluble.

8. The copolymer of claim 1, which is hydrophilic and oleophobic.

9. The copolymer of claim 1, wherein the advancing contact angle of the high surface energy fluid is lower than about 40°.

10. A device comprising:
a surface, where at least part of the surface is coated with a copolymer, the copolymer comprising a first monomer including a hydrophilic group and a hydrophobic group linked to the hydrophilic group, and a second monomer polymerized to the first monomer,
wherein the hydrophobic group is oil-repellant, and
wherein the copolymer is presented on the surface in a configuration and the amount of the copolymer coated onto the surface is adjusted in a manner such that a receding contact angle of a low surface energy fluid on the surface is greater than an advancing contact angle of a high surface energy fluid on the surface.

11. The device of claim 10, wherein the copolymer is non-covalently coated to the surface.

12. The device of claim 10, wherein at least some of the part of the copolymer corresponding to the second monomer contacts the surface.

13. The device of claim 10, wherein the copolymer has a bulky form.

14. The device of claim 10, wherein the surface is water-wettable.

15. The device of claim 10, wherein the surface comprises a water swellable and porous surface or a silica surface.

16. The device of claim 10, wherein the low surface energy fluid is an oil, the high surface energy fluid is water, and the advancing water contact angle is about 40° lower than receding hexadecane contact angle.

17. A device comprising:
a surface, at least part of the surface being coated with a compound, the compound comprising a hydrophilic group and a hydrophobic group linked to the hydrophilic group,
wherein the hydrophobic group is oil-repellant, and
wherein the compound is presented on the surface in a configuration and the amount of the compound coated onto the surface is adjusted in a manner such that a receding contact angle of a low surface energy fluid on the surface is greater than an advancing contact angle of a high surface energy fluid on the surface.

18. The device of claim 17, wherein the compound is covalently coated to the surface.

19. The device of claim 17, wherein the surface comprises a silica surface.

20. The device of claim 17, wherein the compound has a brush-like form.
